(19) United States
(12) Patent Application Publication
(10) Pub. No.: US 2016/0345129 A1
(43) Pub. Date: Nov. 24, 2016

(54) POSITIONING SYSTEM FOR INDOOR AND SURROUNDING AREAS, POSITIONING METHOD AND ROUTE-PLANNING METHOD THEREOF AND MOBILE APPARATUS

(71) Applicants: Owen Hownwun Lee, Plano, TX (US); Yi-Chyun Mitch Tseng, Plano, TX (US)

(72) Inventors: Owen Hownwun Lee, Plano, TX (US); Yi-Chyun Mitch Tseng, Plano, TX (US)

(21) Appl. No.: 15/152,145

(22) Filed: May 11, 2016

Related U.S. Application Data
(60) Provisional application No. 62/163,419, filed on May 19, 2015.

(51) Int. Cl. H04W 4/02; G01C 21/34; H04W 4/04

(52) U.S. Cl. CPC H04W 4/023; H04W 4/021; H04W 4/04; G01C 21/34; H04L 67/18

(57) ABSTRACT

A positioning system includes a wireless device network, a remote server, and a mobile apparatus. The wireless device network deployed over a predefined area includes a first directional RF communication device arranged at a first known location for directionally transmitting first RF signals including first digital identification to form a first signal covered zone and a second directional RF communication device arranged at a second known location for directionally transmitting second RF signals including second digital identification to form a second signal covered zone. The remote server stores arrangement information about the first known locations and the second known locations in predefined area. The mobile apparatus receives at least one of the first or the second RF signals, compares signal strength of the first RF signal with that of the second RF signals, and determines a positioning location based on the arrangement information.

### CROSS REFERENCE TO RELATED APPLICATIONS

This Non-provisional application claims priority to U.S. provisional patent application with Ser. No. 62/163,419 filed on May 19, 2015, the entire contents of which are hereby incorporated by reference.

### BACKGROUND OF THE INVENTION

1. Field of Invention

The invention relates to a positioning system and, in particular, to a positioning system and apparatus for indoor and surrounding areas.

2. Related Art

Indoor Positioning & Navigation System refers to an apparatus and set of methods where networks of devices and algorithms are used to locate mobile devices within buildings and parking garages. Indoor positioning and navigation are regarded as key components of Internet of Things (IoT) and Location Based Services (LBS). To successfully deploy Location Based Services, it is important to have an accurate indoor positioning and navigation system.

There are many radio-based positioning methods based on received signal strength indication (RSSI) from WiFi Access Points (AP) and Bluetooth beacons, magnetic fields footprints, indoor lighting and sensors (accelerometer, gyroscope, e-compass, etc.). Also, there are many methods and software algorithms used for computing position coordinates of portable mobile devices. Triangulation is the most common method involved, using RSSI values measured and collected from multiple radio apparatus/stations to calculate the source's location. Other methods utilize Fingerprinting or Pattern Recognition techniques, which attempt to remember the radio patterns of the pathway in the building.

Current indoor positioning technology mainly employs the triangulation method. The triangulation method has to set at least three wireless access points in a predefined area. When a mobile apparatus enters the predefined area, the distances between the mobile apparatus and the three wireless access points are respectively determined according to the received signal strengths represented as RSSI. Three circles are drawn respectively centered at the locations of the three access points and the radius is the distances between them, converted by the RSSI, to find an intersection point of the three circles. The intersection point is a current positioning location of the mobile apparatus. However, the method requires an excessive amount of computations on the mobile apparatus. Performing the computation, the mobile apparatus will consume a lot of power. Accordingly, the information of the received wireless signal strengths is generally uploaded to the cloud or local server through wireless network for computation, and then the computed location information is transmitted back to the mobile apparatus.

However, as mentioned above, the positioning computation cannot proceed if the mobile apparatus is temporarily unable to connect to the wireless network.

Therefore, it is important to provide a simple and convenient positioning system and method which can improve the efficiency of indoor positioning, be executed on mobile apparatuses, and have the advantages of low power consumption and low computation load.

### SUMMARY OF THE INVENTION

An aspect of the disclosure is to provide a positioning system and positioning method for indoor area and surrounding areas which can reduce computation load.

A positioning system for indoor and surrounding areas is provided. The positioning system includes a wireless device network, a remote server, and a mobile apparatus. The wireless device network is deployed over a predefined area and includes a first directional RF communication device and a second directional RF communication device. The first directional RF communication device (referred Position Beacon B1 or PBeacon B1) directionally transmits a plurality of first RF signals to form a first signal covered zone in the predefined area. The first RF signals include first digital identification. The second directional RF communication device (PBeacon B2) directionally transmits a plurality of second RF signals to form a second signal covered zone in the predefined area. The second RF signals include second digital identification. The remote server stores arrangement information about the first directional RF communication device and the second directional RF communication device at the first known location and the second known location in the predefined area. The mobile apparatus stores the arrangement information, receives at least one of the first RF signals or the second RF signals, and determines a positioning location according to the first digital identification or the second digital identification, the arrangement information, and received signal strength.

In one embodiment, the mobile apparatus receives at least one of the first RF signals and at least one of the second RF signals, compares received signal strength of the first RF signal with that of the second RF signal, and then determines the positioning location based on the arrangement information.

In one embodiment, the mobile apparatus determines the positioning location according to the first digital identification if the received signal strength of the first RF signal is greater than that of the second RF signal, and the mobile apparatus determines the positioning location according to the second digital identification if the received signal strength of the second RF signal is greater than that of the first RF signal.

In one embodiment, the arrangement information is further relevant to the relative relation between the first known location and the second known location.

In one embodiment, the first signal covered zone and the second signal covered zone overlap each other.

In one embodiment, the first signal covered zone and the second signal covered zone do not overlap.

In one embodiment, the remote server further stores map information including a relative positional relation between a layout of the indoor and surrounding areas in the predefined area and locations of the respective directional RF communication devices, and the mobile apparatus is wirelessly connected to the remote server to access the map information.

The mobile apparatus can be disconnected to the remote server once the map information is downloaded.

In one embodiment, the first directional RF communication device and the second directional RF communication device respectively include a RF signal transceiver module and directional antenna module. The RF signal transceiver module generates the first RF signals or the second RF signals. The directional antenna module transmits the first RF signals or the second RF signals to cover the first signal covered zone or the second signal covered zone.

In one embodiment, the first directional RF communication device and the second directional RF communication device respectively include a RF signal transceiver module, an omnidirectional antenna module, and a signal directing module. The RF signal transceiver module generates the first RF signals or the second RF signals. The omnidirectional antenna module transmits the first RF signals or the second RF signals. The signal directing module, together with the omnidirectional antenna module, makes the first RF signals or the second RF signals directional.

In one embodiment, the wireless device network further includes a plurality of directional RF communication devices, and the directional RF communication devices respectively include different digital identifications.

In one embodiment, the mobile apparatus receives at least a target location in the predefined area and plans at least a route according to the positioning location, the target location, and map information including a relative positional relation between a layout of the indoor and surrounding areas in the predefined area and locations of the respective directional RF communication devices.

In one embodiment, the route is formed by connecting the directional RF communication devices between the positioning location and the target location, and a starting point of the route is the location of the first directional RF communication device or the location of the second directional RF communication device.

In one embodiment, the route includes a direction indicator, and the direction indicator indicates the direction towards the next directional RF communication device on the route towards the target location.

A positioning method employed with a wireless device network and a remote server for positioning in indoor and surrounding areas is provided. The wireless device network is deployed over a predefined area and includes a first directional RF communication device and a second directional RF communication device. The remote server stores arrangement information about the first directional RF communication device and the second directional RF communication device at the first known location and the second known location in the predefined area. The positioning method is executed by a mobile apparatus. The mobile apparatus stores the arrangement information. The positioning method includes the following steps: receiving one of a plurality of first RF signals transmitted by the first directional RF communication device or one of a plurality of second RF signals transmitted by the second directional RF communication device, wherein the first RF signals include first digital identification and form a first signal covered zone in the predefined area, and the second RF signals include second digital identification and form a second signal covered zone in the predefined area; and determining a positioning location according to the first digital identification or the second digital identification together with the arrangement information.

In one embodiment, the positioning method further includes: comparing received signal strength of the first RF signal with that of the second RF signal, and then determining the positioning location based on the arrangement information.

In one embodiment, the positioning location is determined according to the first digital identification together with the arrangement information if the received signal strength of the first RF signal is greater than that of the second RF signal, and the positioning location is determined according to the second digital identification together with the arrangement information if the received signal strength of the second RF signal is greater than that of the first RF signal.

In one embodiment, the arrangement information is further relevant to the relative relation between the locations of the first directional RF communication device and the second directional RF communication device.

In one embodiment, the wireless device network further includes a plurality of directional RF communication devices, and the directional RF communication devices respectively include different digital identifications.

A route-planning method employed with a wireless device network and a remote server for positioning in indoor and surrounding areas is provided. The wireless device network is deployed over a predefined area and includes a first directional RF communication device and a second directional RF communication device. The remote server stores arrangement information about the first directional RF communication device and the second directional RF communication device at the first known location and the second known location in the predefined area. The route-planning method is executed by a mobile apparatus, and the mobile apparatus is wirelessly connected to the remote server to access the arrangement information of the directional RF communication devices. The route-planning method includes the following steps: receiving, by the mobile apparatus, one of a plurality of first RF signals transmitted by the first directional RF communication device or one of a plurality of second RF signals transmitted by the second directional RF communication device, wherein the first RF signals include first digital identification and form a first signal covered zone in the predefined area, and the second RF signals include second digital identification and form a second signal covered zone in the predefined area; determining, by the mobile apparatus, a positioning location according to the first digital identification or the second digital identification together with the arrangement information; receiving at least a target location in the predefined area; and planning at least a route according to the positioning location, the target location, and map information including a relative positional relation between a layout of the indoor and surrounding areas and locations of the respective directional RF communication devices.

In one embodiment, the wireless device network includes at least three directional RF communication devices, the directional RF communication devices respectively include different digital identifications, the route is formed by connecting the directional RF communication devices between the positioning location and the target location, a starting point of the route is the first directional RF communication device or the second directional RF communication device, and a terminal point of the route is the first directional RF communication device or the second directional RF communication device which is closest to the target location.

A mobile apparatus applied to a positioning system for indoor and surrounding areas is provided. The positioning system includes a wireless device network, a remote server, and the mobile apparatus. The wireless device network is deployed over a predefined area and includes a first directional RF communication device and a second directional RF communication device. The first directional RF communication device is arranged at a first known location in the predefined area, and the second directional RF communication device is arranged at a second known location in the predefined area. The remote server stores arrangement information about the first directional RF communication device and the second directional RF communication device at the first known location and the second known location in the predefined area. The mobile apparatus includes a memory unit and one or more processing units. The memory unit stores the arrangement information received from the remote server, a positioning method, and a plurality of instructions. The one or more processing units are coupled with the memory unit. The one or more processing units execute the instructions and comprise the following procedures: receiving one of a plurality of first RF signals transmitted by the first directional RF communication device or one of a plurality of second RF signals transmitted by the second directional RF communication device, wherein the first RF signals include first digital identification and form a first signal covered zone in the predefined area, and the second RF signals include second digital identification and form a second signal covered zone in the predefined area; and determining a positioning location according to the first digital identification or the second digital identification together with the arrangement information.

In one embodiment, the one or more processing units execute the instructions and further include the following procedures: comparing received signal strength of the first RF signal with that of the second RF signal, and then determining the positioning location based on the arrangement information.

As mentioned above, the positioning system according to the disclosure compares the received signal strengths and the specific locations of a plurality of directional RF communication devices on the wireless device network so as to locate the current positioning location of a user. Because it only needs to compare the received signal strengths of the directional RF communication devices, the computation load is less than that of the triangulation method of the conventional technology. Therefore, it can effectively save the software and hardware resources of the mobile apparatus and reduce the required power consumption, and the wireless device network can be adjusted according to the predefined area so as to have optimal positioning performance based on client needs.

### BRIEF DESCRIPTION OF THE DRAWINGS

The invention will be better understood from the detailed description and accompanying drawings, which are given for illustration only, and thus are not limitative of the present invention, and wherein:

FIG. 1 is a schematic diagram showing a highly directional RF Position Beacon (PBeacon) module retrofit or built-in with light fixtures with a unique ID, and showing the covered zone thereof;

FIG. 2 is a schematic diagram showing a positioning system according to an embodiment;

FIG. 3 is a flow chart showing the steps of a positioning method according to an embodiment;

FIG. 4 is a flow chart showing the steps of a positioning method according to another embodiment;

FIG. 5 is a flow chart showing the steps of a route-planning method according to an embodiment;

FIG. 6A is a schematic diagram showing that the mobile apparatus displays a route plan in the predefined area;

FIG. 6B is an enlarged image of the route plan on the mobile apparatus shown in FIG. 6A;

FIG. 7A is a schematic diagram showing that the positioning system is applied to a predefined area of multiple floors;

FIG. 7B is a schematic diagram showing that the mobile apparatus displays a route plan in the predefined area of multiple floors;

FIG. 8A is a schematic diagram showing the first directional RF communication device;

FIG. 8B is another schematic diagram showing the first directional RF communication device; and

FIG. 8C is another schematic diagram showing the first directional RF communication device.

### DETAILED DESCRIPTION OF THE INVENTION

The embodiments of the invention will be apparent from the following detailed description, which proceeds with reference to the accompanying drawings, wherein the same references relate to the same elements.

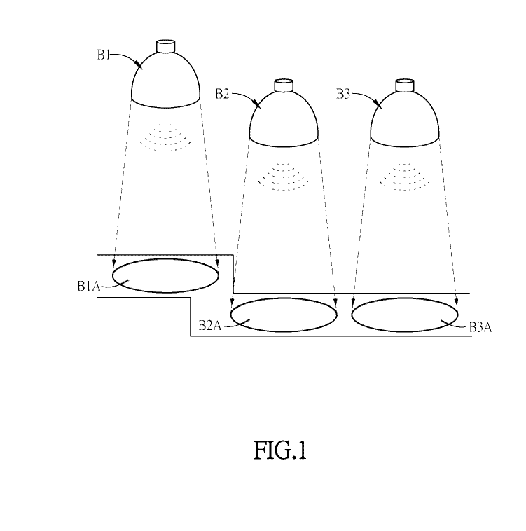

Referring to FIG. 1, it is a schematic diagram showing a highly directional RF Position Beacon (PBeacon) module retrofit or built-in with light fixtures with a unique ID, and showing the covered zone thereof. The positioning system and apparatus of the present invention uses retrofit, built-in highly directional Radio Frequency (RF) transmitter/receiver modules with predefined unique Identification (ID), hereinafter also named as “digital identification (digital ID)”, as Position Beacons (PBeacons, hereinafter also named as the “directional RF communication devices” B1, B2, and B3), which can be integrated with lighting modules, audio speakers, visual display signs, or as a stand-alone module to serve as reference points within a predefined area, which the indoor navigation and position shall be operated on.

Furthermore, the location & position coordinate information of the PBeacons in the predefined area for precise indoor positioning and navigation are stored in the database, which can be downloaded prior to starting the indoor navigation & positioning process.

The highly-directional RF signal from the transceiver module of each PBeacon is achieved by using either a highly-directional antenna module for the RF transceiver module or a parabolic reflector trim with the antenna module of the RF transceiver module located on the focal point of the parabolic shaped reflector trim.

The embodiments described below present and provide a simple, robust and efficient means by using a set of pre-deployed PBeacons each with a highly-directional RF signal & a uniquely assigned digital identification (Digital ID) within the predefined area, where the location and navigation operation is performed, together with a database (hereinafter also named as the “remote server”) containing the mapping information of the location of each of the PBeacons, a Physical Floor Layout (hereinafter also named as the “layout of the indoor and surrounding area”), a table mapping each PBeacon location to the Physical Floor Layout to hold the positions of PBeacons as related to physical floor location.

A mobile apparatus, with preloaded PBeacon location mapping information with respect to the covered area with an optimal route to the target once the target is specified, can perform the location and navigation routines and guide the user with a Graphical User Interface (GUI) display on the mobile apparatus. The mobile apparatus can detect the presence of PBeacons in its neighborhood area according to the received RF signal strength and convert the signal strength into Received Signal Strength Indication (RSSI) format or values for location determination; furthermore, the mobile apparatus may also be equipped with orientation detection capability, such as, but not limited to, an electronic compass (e-compass) or magnetic sensor to jointly determine the navigation instructions and guide the user.

In one embodiment, the PBeacons serve as reference points in the predefined area; moreover, the PBeacons can served not only as reference points in the area, but they can also form an electronic fence of the predefined fields by connecting the PBeacons placed at the boundary of the predefined area.

The application software (APP) of the mobile apparatus will associate the strength of the RSSI of the PBeacons in the neighborhood of the mobile apparatus and first determine the current location based on the Digital ID of the PBeacon with the strongest received RSSI value and a location that can be determined through a database containing mapping information of the Digital ID of the PBeacon and the physical location.

The target location is determined by finding the nearest reference PBeacon on the Physical Floor Layout near the target. Once the reference PBeacon closest to the target location is determined, the optimal route from the current location to the target location can be established by identifying all the associated PBeacons, which have been mapped in the Physical Floor Layout; furthermore, the two-dimensional PBeacon location information is converted into a linear sequence so that the navigation can be conducted progressively, advancing the user from the current location, represented by the nearest PBeacon, towards the next PBeacon using the directions provided by the apparatus's built-in e-compass or magnetic sensor until a target area is reached.

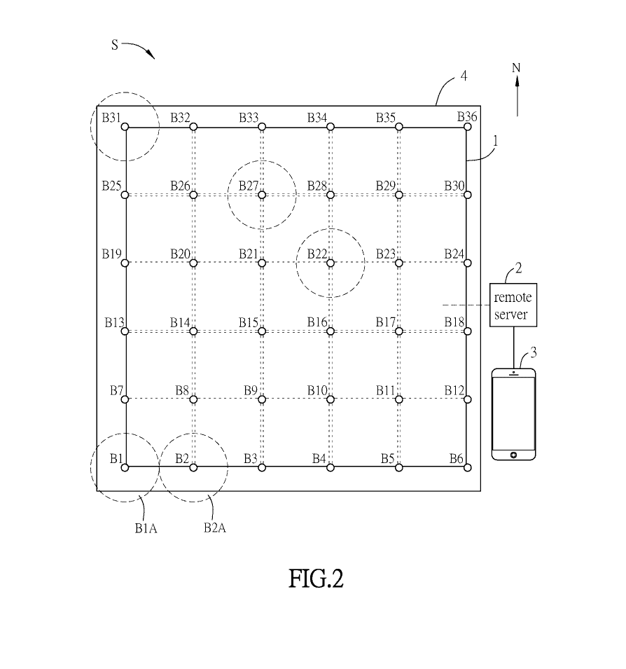

Referring to FIG. 2, it is a schematic diagram showing a positioning system S for indoor and surrounding areas according to an embodiment. The positioning system S includes a wireless device network 1, a remote server 2, and a mobile apparatus 3. The top of the figure is the north (N, the direction indicated by the arrow at the top right of the figure). The wireless device network 1 of the embodiment is a network including a plurality of directional RF communication devices. In the embodiment, the wireless device network 1 including 36 directional RF communication devices (also known as PBeacons) B1-B36 is illustrated for example. Moreover, in the embodiment, the directional RF communication devices B1-B36 are devices which can transmit directional RF signals, for example, WiFi wireless devices (IEEE 802.11) which can transmit directional RF signals, Bluetooth wireless devices, Bluetooth low energy wireless devices, or the likes. The details are described below.

The wireless device network 1 is deployed over a predefined area 4. In the embodiment, the predefined area 4 is a range of area having positioning or navigation needs, for example but not limited to, a parking lot, hypermarket, department store, business/residential building, or other indoor spaces. That is to say, in the embodiment, “indoor and surrounding areas” is the above mentioned indoor (or underground) parking lot, hypermarket, department store, business/residential building, or other indoor spaces and the surrounding area thereof. Moreover, “surrounding area” may be, for example, the accompanying outdoor parking lot, plaza, adjacent road or open area of the above mentioned hypermarket, department store, business/residential building, or other buildings, but it is not limited thereto. In the embodiment, the directional RF communication devices B1-B36 are arranged in the predefined area 4. Each location where the directional RF communication devices B1-B36 are respectively arranged in the predefined area 4 is regarded as a known location for the positioning system S. As shown in FIG. 2, the directional RF communication devices B1-B36 according to the embodiment are arranged in the predefined area 4 in a checkerboard pattern. The directional RF communication devices may also be arranged in the predefined area 4 in a different pattern according to actual needs. For example, the directional RF communication devices B1-B36 may also be arranged along a specific walking area in the predefined area 4 (the specific walking area may be a straight area, a non-linear area, or an area having a route plan).

Preferably, in the embodiment, the positioning system S for indoor and surrounding areas includes the remote server 2. The remote server 2 stores arrangement information in the predefined area 4 and map information including a relative positional relation between a layout of the indoor and surrounding areas and locations of the respective directional RF communication devices B1-B36. For example, the map information may be a map of the predefined area where the wireless device network 1 is deployed, and it may also include Floor Plan Layout (Physical Floor Layout) plus the location information of the PBeacons. In the embodiment, the arrangement information refers to the relative relation between the respective known locations which the directional RF communication devices B1-B36 are arranged at. The mobile apparatus 3 according to the embodiment may be, for example but not limited to, a tablet computer, a personal digital assistant, a smart mobile phone, or other electronic apparatuses. The following mobile apparatus 3 is illustrated by taking a smart mobile phone for example. When a user carries the mobile apparatus 3 and enters the predefined area 4, the mobile apparatus 3 can be wirelessly connected to the remote server 2 through wireless network to download the arrangement information and the map information of the predefined area 4 on the remote server 2 and store them on the mobile apparatus 3. The map information including a relative positional relation between the layout of the indoor and surrounding areas and locations of the respective directional RF communication devices B1-B36 refers to map information including a relative positional relation between the indoor layout of the building (including the surrounding area thereof) where the positioning system S is set and the locations of the respective directional RF communication devices B1-B36. The map information allows the user or the system to realize the actual location which each of the directional RF communication devices B1-B36 is installed on in the indoor area. In other embodiments, the arrangement information and the map information of the predefined area 4 may be stored on the mobile apparatus 3 in advance, so the disclosure is not limited. Moreover, store information, discount information, and other information can also be stored on the remote server 2 for users to download.

As mentioned above, the directional RF communication devices B1-B36 according to the embodiment can transmit directional RF signals, and the RF signals transmitted by different directional RF communication devices B1 -B36 include different digital identifications (Digital IDs). The digital identification is usually a set of identification codes enclosed in a RF signal packet. Receiving the wireless signals transmitted by different directional RF communication devices B1-B36, the mobile apparatus 3 can identify that the RF signals are transmitted by which directional RF communication device according to the digital identification (the identification codes) enclosed in the RF signal packet. Accordingly, the positioning system S according to the embodiment can determine the positioning location of the mobile apparatus 3, namely locate the mobile apparatus 3, based on the RF signals transmitted by the directional RF communication devices B1-B36 and the relation between the specific configuration locations of the directional RF communication devices B1-B36 (i.e. the locations which the respective directional RF communication devices B1-B36 are installed on in the predefined area 4). The following description takes the first directional RF communication device B1 and the second directional RF communication device B2 as an example for illustration.

In the embodiment, the mobile apparatus 3 includes a memory unit 31, one or more processing units, and a display unit 33. In addition to the above mentioned arrangement information, the memory unit 31 also stores a positioning method and a plurality of instructions corresponding to the positioning method. The processing unit 32 is coupled with the memory unit 31 and executes the positioning method.

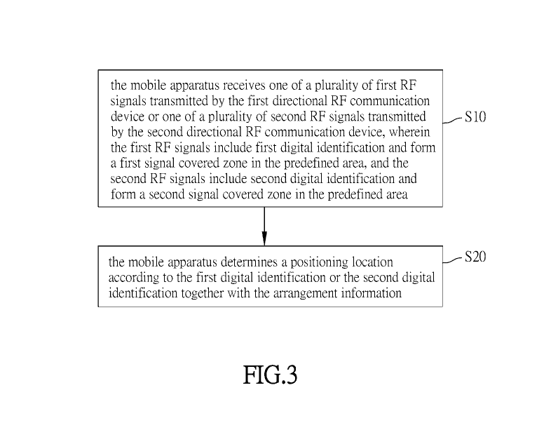

Referring to FIG. 3, it is a flow chart showing the steps of a positioning method for indoor and surrounding areas according to an embodiment of the disclosure. The positioning method of the disclosure at least includes the following steps: receiving one of a plurality of first RF signals transmitted by a first directional RF communication device or one of a plurality of second RF signals transmitted by a second directional RF communication device, wherein the first RF signals include first digital identification and form a first signal covered zone in a predefined area, and the second RF signals include second digital identification and form a second signal covered zone in the predefined area (step S10); and determining a positioning location according to the first digital identification or the second digital identification together with the arrangement information (step S20).

As shown in FIG. 2, in the embodiment, the first directional RF communication device B1 directionally transmits a plurality of first RF signals which include first digital identification, and the second directional RF communication device B2 directionally transmits a plurality of second RF signals which include second digital identification. As mentioned above, the mobile apparatus 3 downloads and accesses the arrangement information from the remote server 2. In the embodiment, the arrangement information refers to the relative relation between the specific locations of the first directional RF communication device B1 and the second directional RF communication device B2 (i.e. the specific locations which the respective directional RF communication devices B1, B2 are installed on in the predefined area 4). Therefore, if the mobile apparatus 3 receives the first RF signals in the step S10, the mobile apparatus 3 can identify that the signals are transmitted by the first directional RF communication device B1 due to the first digital identification and then identify that the mobile apparatus 3 is located near the first directional RF communication device B1 in the step S20. If the mobile apparatus 3 receives the second RF signals (step S10), the mobile apparatus 3 can identify that the signals are transmitted by the second directional RF communication device B2 due to the second digital identification (step S20) and then identify that the mobile apparatus 3 is located near the second directional RF communication device B2.

In detail, a plurality of first RF signals transmitted by the first directional RF communication device B1 may form a first signal covered zone B1A in the predefined area 4, and a plurality of second RF signals transmitted by the second directional RF communication device B2 may form a second signal covered zone B2A in the predefined area 4. The signal covered zone according to the embodiment is a range of area covered by the RF signals. In the embodiment, take the hypermarket for example, the first directional RF communication device B1 and the second directional RF communication device B2 are disposed in the upper area of the predefined area 4, for example, on the ceiling or the lighting. Accordingly, the first signal covered zone B1A and the second signal covered zone B2A are formed between the upper area and the ground of the predefined area 4. In the embodiment, circular areas are formed on the ground of the predefined area 4 respectively by the first signal covered zone B1A and the second signal covered zone B2A (as shown in FIG. 2). However, the shapes formed on the ground of the predefined area 4 respectively by the first signal covered zone B1A and the second signal covered zone B2A can be changed into other shapes, for example, rectangular or elliptical shape, according to the actual needs. The disclosure does not limit the shapes. Moreover, the first signal covered zone B1A and the second signal covered zone B2A may overlap each other or not overlap. In the embodiment, the first signal covered zone B1A and the second signal covered zone B2A overlap each other. However, it can be adjusted according to the actual needs, and it is not limited in the disclosure.

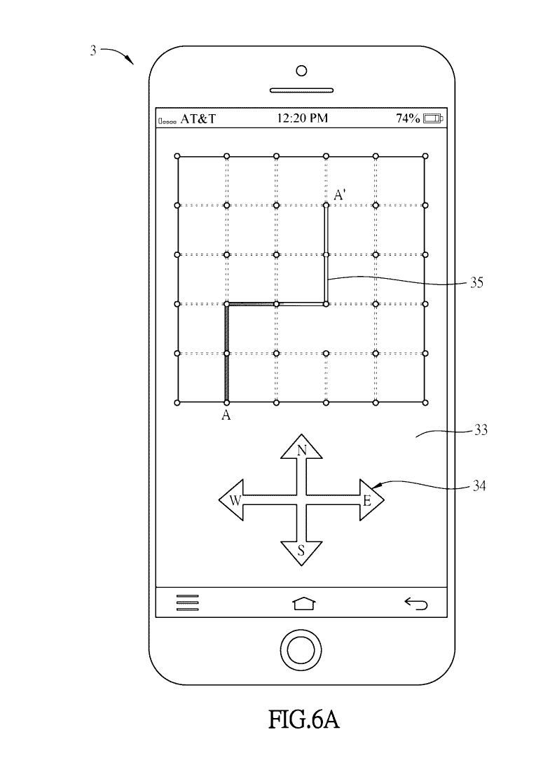

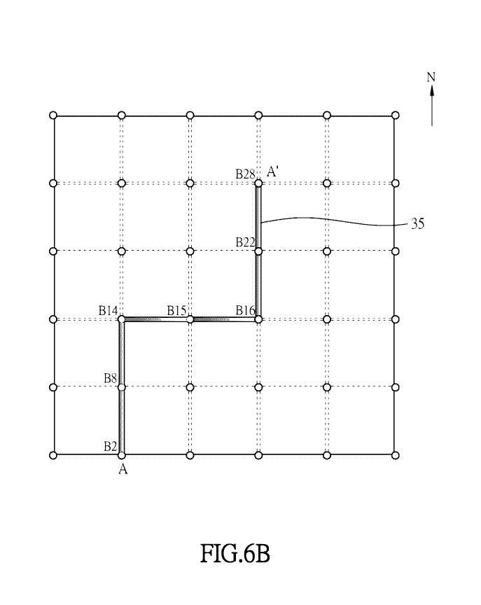

In the step S10, the mobile apparatus 3 may receive the first RF signal or the second RF signal so as to determine the positioning location A, namely the location of the mobile apparatus 3, according to the first digital identification or the second digital identification in the step S20. For example, when the mobile apparatus 3 of the embodiment is located in the second signal covered zone B2A, at this time, the mobile apparatus 3 can receive the second RF signal (step S10) and identify its location is near the second directional RF communication device B2 according to the second digital identification (step S20). Moreover, the processing unit 32 of the mobile apparatus 3 may mark the positioning location A on the map information of the predefined area 4 which is stored in the memory unit 31, and the marked positioning location A is displayed on the display unit 33 of the mobile apparatus 3. Referring to FIG. 6A, the positioning location A corresponds to the location of the second directional RF communication device B2 shown in FIG. 2 for users' reference. Certainly, in other embodiments, the mobile apparatus 3 may be located in the first signal covered zone B1A, and the display unit 33 can display the positioning location A corresponding to the first directional RF communication device B1 shown in FIG. 2 after the processing unit 32 executes the above mentioned step S10 and step S20. The details are omitted here.

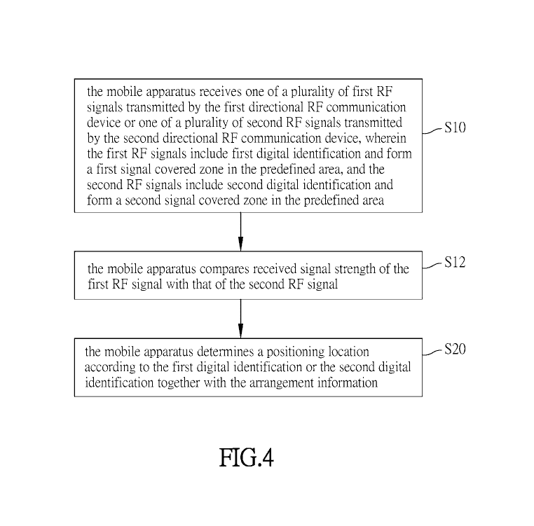

FIG. 4 is a flow chart showing the steps of a positioning method according to another embodiment. In this embodiment, the positioning method for indoor and surrounding areas is similarly executed by the mobile apparatus 3. As shown in FIG. 4, preferably, before the step 20, the method may further include the step S12: comparing received signal strength of the first RF signal with that of the second RF signal. In detail, located on a location where the first signal covered zone B1A and the second signal covered zone B2A overlap each other, the mobile apparatus 3 can receive the first RF signal and the second RF signal simultaneously. In this case, proceed to the step S12 first. The received signal strength of the first RF signal is compared with that of the second RF signal to determine whose signal strength is greater, and then the positioning location A is determined according to the digital identification of the stronger received signal and the location of the device which transmitted the stronger signal (i.e. the arrangement information). For example, if the received signal strength of the first RF signal is greater than that of the second RF signal, the mobile apparatus 3 determines the positioning location A according to the first digital identification and the location of the first directional RF communication device (i.e. the arrangement information). Then, the display unit 33 of the mobile apparatus 3 will display that the positioning location A is located in the first signal covered zone B1A of the first directional RF communication device B1. If the received signal strength of the second RF signal is greater than that of the first RF signal, the mobile apparatus 3 determines the positioning location A according to the second digital identification and the specific configuration location of the second directional RF communication device (i.e. the arrangement information). That is to say, the display unit 33 of the mobile apparatus 3 will display that the positioning location A is located in the second signal covered zone B2A of the second directional RF communication device B2.

Preferably, receiving a plurality of wireless signals, the mobile apparatus 3 may compare the received signal strengths of those wireless signals with a predetermined threshold. The subsequent steps of comparison and determination of the digital identification (step S12 and step S20) are executed only if the received signal strength is greater than the predetermined threshold. Thus, the distant directional RF communication devices (B1-B36) can be filtered at first.

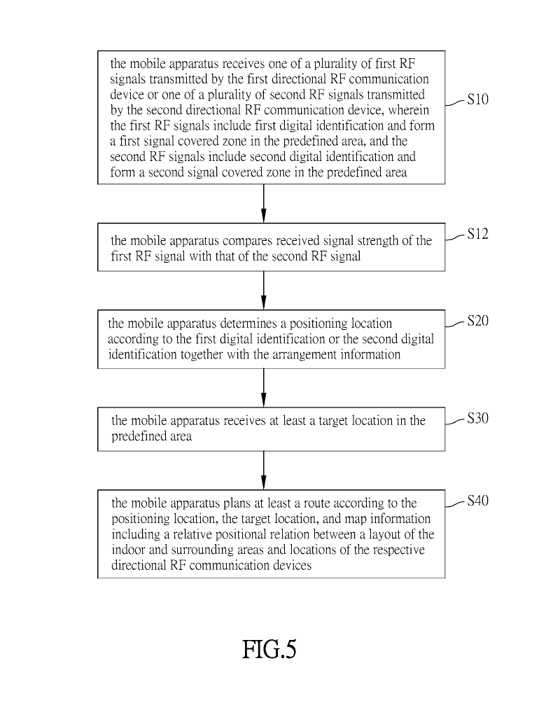

In addition to positioning, the positioning system S for indoor and surrounding areas and the positioning method executed by the mobile apparatus 3 according to the embodiment also have navigation function. Referring to FIG. 5, it is a flow chart showing the steps of a route-planning method according to an embodiment. As shown in FIG. 5, the route-planning method of the embodiment includes steps S10 and S20, and preferably includes step S12. Steps S10, S12 and S20 are the same as described above. The route-planning method further includes step S30: receiving at least a target location in the predefined area, and step S40: planning at least a route according to the positioning location, the target location, and map information including a relative positional relation between a layout of the indoor & surrounding areas and locations of the respective directional RF communication devices. The details are further illustrated together with FIG. 6A and FIG. 6B.

Referring to FIG. 6A and FIG. 6B, FIG. 6A is a schematic diagram showing that the mobile apparatus shown in FIG. 2 displays a route plan in the predefined area, and FIG. 6B is an enlarged image of the route plan on the mobile apparatus shown in FIG. 6A. In FIG. 6B, the top of the figure is the north (N, the direction indicated by the arrow at the top right of the figure). First, in the embodiment, the display unit 33 of the mobile apparatus 3 is a touch display unit, so users can perform physical actions such as click, touch and press directly on the display unit 33. The physical action is transformed into a signal by the firmware of the mobile apparatus 3, and then the signal is transformed into an input event through the input module driver. The input event can cause the program to respond correspondingly. For example, if a user wants to buy a sofa in a hypermarket and the sofa display zone is found out to be located on a target location A′ from the information of the hypermarket, the user can directly input the target location A′ into the mobile apparatus 3, namely the above mentioned input event. The target location A′ may be the number of the adjacent directional RF communication device, for example, B28 in the embodiment. The processing unit 32 can respond correspondingly according to the input event. For example, in the embodiment, the processing unit 32 plans at least a route 35 according to the positioning location A (the user's current location) and the target location A′ together with the wireless device network 1. That is to say, the starting point of the route 35 is the positioning location A, the terminal point of the route 35 is the target location A′, and the positioning system S plans the route 35 according to the starting point (the positioning location A) and the terminal point (the target location A′). As shown in FIG. 6B, the route 35 may be formed by the second directional RF communication device B2, the eighth directional RF communication device B8, the fourteenth directional RF communication device B14, the fifteenth directional RF communication device B15, the sixteenth directional RF communication device B16, the twenty-second directional RF communication device B22, and the twenty-eighth directional RF communication device B28. Accordingly, the route 35 is formed by connecting the directional RF communication devices between the positioning location A and the target location A′.

In other embodiments, the positioning method may further include a retrieval program, and users can directly enter the keyword “sofa”. In this case, the processing unit 32 finds out the sofa display zone from the information of the hypermarket which is stored in the memory unit 31 beforehand, marks the target location A′ on the map information of the hypermarket, and then displays it on the display unit 33 for users' reference. Further, as mentioned above, a preferable route is planned to guide the user to the sofa display zone to buy products.

Preferably, as shown in FIG. 6A, in addition to the arrangement information and the map information corresponding to the wireless device network 1, the display unit 33 of the mobile apparatus 3 may also display a direction indicator 34. In other embodiments, the display unit 33 of the mobile apparatus 3 may only display the direction indicator 34. The direction indicator 34 according to the embodiment is used to point out the direction forward for the user. For example, as shown in FIG. 6B, it refers to the direction from the positioning location A toward the next directional RF communication device (i.e. the eighth directional RF communication device B8 in the embodiment) in the route 35. That is to say, the direction indicator 34 indicates the user to go north when the user is on the positioning location A, the direction indicator 34 still displays the direction toward the north when the user arrives on the location of the eighth directional RF communication device B8, the direction indicator 34 displays the direction toward the east when the user arrives on the location of the fourteenth directional RF communication device B14, and so on, until the user reaches the target position A′. In the embodiment, the direction indicator 34 indicates that the user should go toward which directional RF communication device next, so the display unit 33 only needs to display the direction indicator 34 to achieve the navigation function which guides the user to the target position A′.

Moreover, the predefined area 4 may further include a plurality of sub-areas. Because the mobile apparatus 3 can be wirelessly connected to the remote server 2 to access the information of the hypermarket corresponding to the predefined area 4, the mobile apparatus 3 can provide the information of the hypermarket of different sub-area while the user moves to a different location.

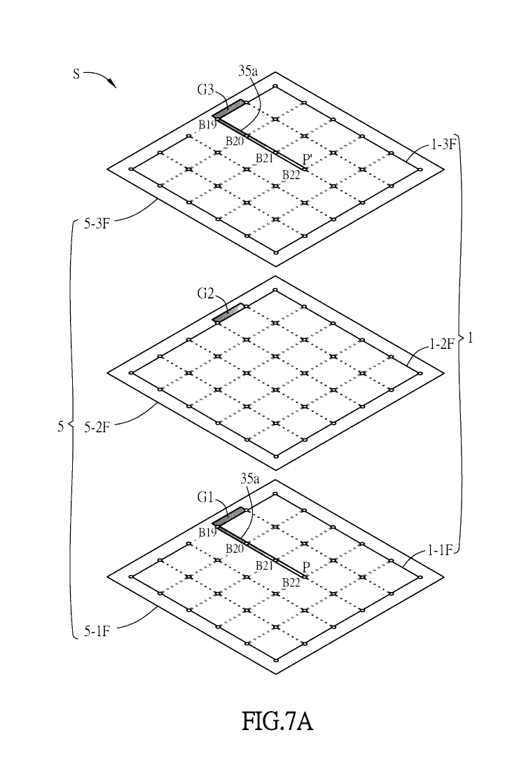

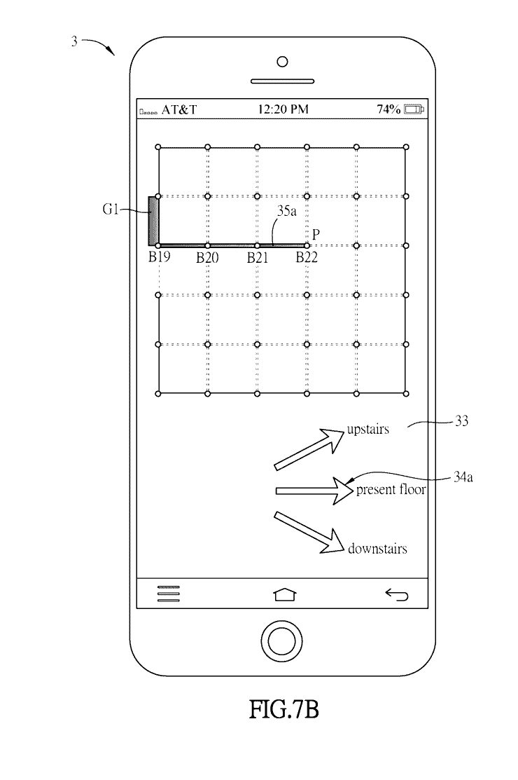

In one embodiment, the positioning system S for indoor and surrounding areas may also be applied to the predefined area 5 having multiple floors. Referring to FIG. 7A and FIG. 7B, FIG. 7A is a schematic diagram showing that the positioning system is applied to a predefined area of multiple floors, and FIG. 7B is a schematic diagram showing that the mobile apparatus displays a route plan in the predefined area of multiple floors.

In this embodiment, the positioning system S includes a first wireless device network 1-1F, a second wireless device network 1-2F, and a third wireless device network 1-3F which are respectively arranged at the first floor 5-1F, the second floor 5-2F, and the third floor 5-3F of the predefined area 5.

The first floor 5-1F, the second floor 5-2F, and the third floor 5-3F of the predefined area 5 respectively include a first gateway G1, a second gateway G2, and a third gateway G3 leading to the upstairs and downstairs. The first gateway G1, the second gateway G2, and the third gateway G3 may be stairs, elevators, escalators, or ramped walkways. When a user inputs a target position P′ into the mobile apparatus 3, the mobile apparatus 3 plans a route 35a according to the positioning location P of the user and the target position P′. Namely, the starting point of the route 35a is the positioning location P, the terminal point of the route 35a is the target position P′, and the mobile apparatus 3 plans the route 35a according to the starting point (the positioning location P) and the terminal point (the target position P′). The route 35a starts from the twenty-second directional RF communication device B22 of the first floor 5-1F of the predefined area 5 toward the twenty-first directional RF communication device B21 and the twentieth directional RF communication device B20, and reaches the nineteenth directional RF communication device B19. In the embodiment, the direction indicator 34a may also point out the direction of floor such as “upstairs”, “present floor”, and “downstairs” shown in FIG. 7B. When the user reaches the nineteenth directional RF communication device B19, the mobile apparatus 3 displays the direction indicator 34a of “upstairs” to indicate the user to go to the third floor 5-3F. After the user reaches the third floor 5-3F, the mobile apparatus 3 further prompts the user to walk out of the gateway G3 toward the nineteenth directional RF communication device B19, the twentieth directional RF communication device B20, the twenty-first directional RF communication device B21, and the twenty-second directional RF communication device B22 of the third floor 5-3F according to the route 35a planned by the processing unit 32. When the user reaches the location of the twenty-second directional RF communication device B22, the mobile apparatus 3 informs that the user has already reaches the target location P′. Similarly, the route 35a is formed by connecting the directional RF communication devices between the positioning location P and the target location P′. The direction indicator 34a according to the embodiment may indicate the user to walk upstairs, downstairs, or in the present floor according to the actual needs.

The directional RF communication devices B1-B36 are all wirelessly connected to the remote server 2 which can plan the uses of the directional RF communication devices B1-B36 in various regions of the predefined area 4. Accordingly, the remote server 2 may set the directional RF communication devices B1-B6, B7, B12, B13, B18, B19, B24, B25, B30, and B31 through B36, which are arranged at the boundary of the wireless device network 2 as boundary directional RF communication devices. If a consumer who carries the mobile apparatus 3 exceeds the boundary directional RF communication devices, the remote server 2 will send a warning message to the consumer through the mobile apparatus 3.

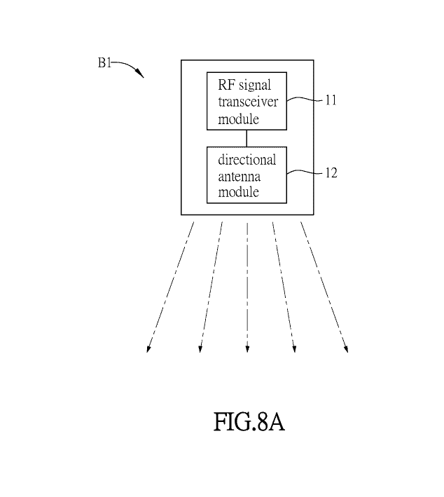

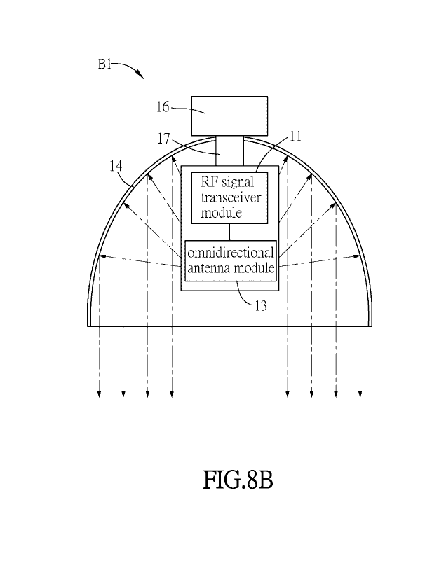

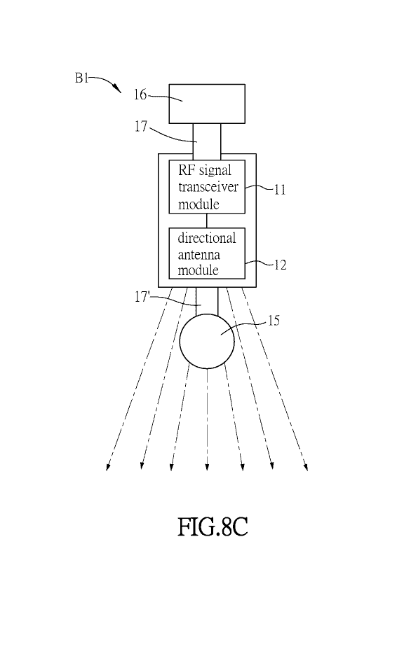

Referring to FIG. 8A to FIG. 8C, the first directional RF communication device B1 is taken for example in FIG. 8A, FIG. 8B, and FIG. 8C. Because the structures of other directional RF communication devices B2-B36 are identical to that of the first directional RF communication device B1, they are omitted here.

Referring to FIG. 8A, it is a schematic diagram showing the first directional RF communication device. The first directional RF communication device B1 includes a RF signal transceiver module 11 and a directional antenna module 12. The RF signal transceiver module 11 is electrically connected to the directional antenna module 12. Moreover, the RF signal transceiver module 11 generates a plurality of RF signals and transmits them to the directional antenna module 12. The RF signal transceiver module 11 may be, for example but not limited to, a WiFi wireless device (IEEE 802.11), Bluetooth wireless device, Bluetooth low energy wireless device, ISM band radio signal device or the like. The directional antenna module 12 which is a directional antenna receives the RF signals generated by the RF signal transceiver module 11 and transmits the RF signals not omnidirectionally. In other words, the signals are transmitted in the vertical or horizontal direction not in 360-degree all directions. For example, the directional antenna module 12 only transmits signals to a region of an included angle of 120 degrees in front of the antenna. The directional antenna module 12 may adjust the region which the RF signals are transmitted to according to the actual needs. Accordingly, the first directional RF communication device B1 may form the first signal covered zone B1A in the predefined area 4 (as shown in FIG. 2).

Referring to FIG. 8B, it is another schematic diagram showing the first directional RF communication device. In this embodiment, the first directional RF communication device B1 includes a RF signal transceiver module 11, an omnidirectional antenna module 13, and a signal directing module 14. The RF signal transceiver module 11 is electrically connected to the omnidirectional antenna module 13. Moreover, the RF signal transceiver module 11 generates a plurality of wireless signals and transmits them to the omnidirectional antenna module 13. The omnidirectional antenna module 13 which is an omnidirectional antenna transmits the wireless signals 360 degrees in the vertical plane or in the horizontal plane. The first directional RF communication device B1 shown in FIG. 8B utilizes the signal directing module 14 to transmit directional wireless signals. Further, the omnidirectional antenna module 13 according to the embodiment may be replaced by the directional antenna module 12, which does not hinder transmitting directional wireless signals. The signal directing module 14 is a parabolic reflector trim, and its inner surface is coated with at least a reflective material layer for reflecting wireless signals to reflect the RF signals transmitted by first directional RF communication device. In FIG. 8B, the omnidirectional antenna module 13 is disposed at or near the focal point of the signal directing module 14 (parabolic reflector trim) so as to effectively concentrate the wireless signals to the opening region of the signal directing module 14 but not to transmit the wireless signals omnidirectionally (360 degrees). Therefore, the first directional RF communication device B1 can form the first signal covered zone B1A in the predefined area 4 (as shown in FIG. 2). In practical use, the first directional RF communication device B1 may be employed with lighting equipment in the indoor and surrounding areas. As shown in FIG. 8B, the RF signal transceiver module 11 and the omnidirectional antenna module 13 can be installed on the AC/DC power source 16 which is originally provided with a light bulb through an adapter 17, so the signal directing module 14 can continue to use the original parabolic lampshade of the lighting equipment. Thereby, the originally installed lighting equipment can be directly employed while the first directional RF communication device B1 is installed (other directional RF communication devices as well). For example, the first directional RF communication device B1 according to the embodiment is installed on the AC/DC power source 16 after removing the light bulb. Therefore, the deployment of the wireless device network 1 is convenient but not necessary to install additional hardware.

Referring to FIG. 8C, it is another schematic diagram showing the first directional RF communication device. In this embodiment, the first directional RF communication device B1 includes a RF signal transceiver module 11 and a directional antenna module 12. The RF signal transceiver module 11 generates a plurality of wireless signals and transmits them to the directional antenna module 12. Like the directional antenna module 12 shown in FIG. 8A, the directional antenna module 12 does not transmit the RF signals omnidirectionally and may adjust the region which the RF signals are transmitted to according to the actual needs. Therefore, the first directional RF communication device B1 according to the embodiment may also form the first signal covered zone B1A in the predefined area 4 (as shown in FIG. 2). In practical use, similar to FIG. 8B, the first directional RF communication device B1 may be employed with lighting equipment or other electronic equipment in the indoor and surrounding areas. As shown in FIG. 8C, the RF signal transceiver module 11 and the directional antenna module 12 can be installed on the AC/DC power source 16 which is originally provided with an electronic device through an adapter 17, and the electronic device 15 (e.g. loudspeaker, light bulb, sirens, or the like) which is formerly installed on the AC/DC power source 16 is connected to the RF signal transceiver module 11 and the directional antenna module 12 through another adapter 17′. Thereby, the originally installed electronic equipment can be directly employed while the first directional RF communication device B1 is installed (other directional RF communication devices as well). For example, the first directional RF communication device B1 according to the embodiment is installed on the AC/DC power source 16 after removing the electronic device 15, and then the electronic device 15 is installed on the first directional RF communication device B1. Therefore, the deployment of the wireless device network 1 is convenient but not necessary to install additional hardware. Further, it does not hinder the function of the original electronic equipment.

A positioning method employed with a wireless device network and a remote server for positioning in indoor and surrounding areas is further provided, the positioning method is executed by a mobile apparatus, and the mobile apparatus stores arrangement information. A mobile apparatus applied to a positioning system is also provided. The positioning system includes a wireless device network, a remote server, and the mobile apparatus. The mobile apparatus includes a memory unit and one or more processing units. The memory unit stores arrangement information, a positioning method, and a plurality of instructions. The one or more processing units are coupled with the memory unit, and the one or more processing units execute the positioning method and the corresponding instructions. The details of the mobile apparatus and the executed positioning method thereof may refer to the above description, so they are not repeated here.

In summary, the positioning system according to the disclosure compares the received signal strengths of a plurality of directional RF communication devices on the wireless device network so as to locate the current positioning location of a user. Because it only needs to compare the received signal strengths of the directional RF communication devices, the computation load is less than that of the triangulation method of the conventional technology. Therefore, it can effectively save the software and hardware resources of the mobile apparatus and reduce the required power consumption, and the wireless device network can be adjusted according to the predefined area so as to have optimal positioning performance based on client needs.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A positioning system for indoor and surrounding areas, comprising:
a wireless device network deployed over a predefined area and comprising:
a first directional RF communication device arranged at a first known location in the predefined area for directionally transmitting a plurality of first RF signals to form a first signal covered zone in the predefined area, wherein the first RF signals include first digital identification; and
a second directional RF communication device arranged at a second known location in the predefined area for directionally transmitting a plurality of second RF signals to form a second signal covered zone in the predefined area, wherein the second RF signals include second digital identification;
a remote server storing arrangement information about the first directional RF communication device and the second directional RF communication device at the first known location and the second known location in the predefined area; and
a mobile apparatus wirelessly connected to the remote server to access the arrangement information, receiving at least one of the first RF signals or the second RF signals, and determining a positioning location according to the first digital identification or the second digital identification together with the arrangement information.

2. The positioning system of claim 1, wherein the mobile apparatus receives at least one of the first RF signals and at least one of the second RF signals, compares received signal strength of the first RF signal with that of the second RF signal, and then determines the positioning location based on the arrangement information.

3. The positioning system of claim 2, wherein the mobile apparatus determines the positioning location according to the first digital identification if the received signal strength of the first RF signal is greater than that of the second RF signal, and the mobile apparatus determines the positioning location according to the second digital identification if the received signal strength of the second RF signal is greater than that of the first RF signal.

4. The positioning system of claim 1, wherein the arrangement information is further relevant to the relative relation between the first known location and the second known location.

5. The positioning system of claim 1, wherein the remote server further stores map information including a relative positional relation between a layout of the indoor and surrounding areas and locations of the respective directional RF communication devices, and the mobile apparatus is wirelessly connected to the remote server to access the map information.

6. The positioning system of claim 1, wherein the first directional RF communication device and the second directional RF communication device respectively comprise:
a RF signal transceiver module generating the first RF signals or the second RF signals; and
a directional antenna module transmitting the first RF signals or the second RF signals to cover the first signal covered zone or the second signal covered zone.

7. The positioning system of claim 1, wherein the first directional RF communication device and the second directional RF communication device respectively comprise:
a RF signal transceiver module generating the first RF signals or the second RF signals;
an omnidirectional antenna module transmitting the first RF signals or the second RF signals; and
a signal directing module, together with the omnidirectional antenna module, making the first RF signals or the second RF signals directional.

8. The positioning system of claim 1, wherein the wireless device network further comprises a plurality of directional RF communication devices, and the directional RF communication devices respectively include different digital identifications.

9. The positioning system of claim 8, wherein the mobile apparatus receives at least a target location in the predefined area and plans at least a route according to the positioning location, the target location, and map information including a relative positional relation between a layout of the indoor and surrounding areas in the predefined area and locations of the respective directional RF communication devices.

10. The positioning system of claim 9, wherein the route is formed by connecting the directional RF communication devices between the positioning location and the target location, and a starting point of the route is the location of the first directional RF communication device or the location of the second directional RF communication device.

11. The positioning system of claim 10, wherein the route comprises a direction indicator, and the direction indicator indicates the direction towards the next directional RF communication device on the route towards the target location.

12. A positioning method employed with a wireless device network and a remote server for positioning in indoor and surrounding areas, wherein the wireless device network is deployed over a predefined area and includes a first directional RF communication device and a second directional RF communication device, the remote server stores arrangement information about the first directional RF communication device and the second directional RF communication device at the first known location and the second known location in the predefined area, the positioning method is executed by a mobile apparatus, and the mobile apparatus is wirelessly connected to the remote server to access the arrangement information of the directional RF communication devices, the positioning method comprising:
receiving, by the mobile apparatus, one of a plurality of first RF signals transmitted by the first directional RF communication device or one of a plurality of second RF signals transmitted by the second directional RF communication device, wherein the first RF signals include first digital identification and form a first signal covered zone in the predefined area, and the second RF signals include second digital identification and form a second signal covered zone in the predefined area; and
determining, by the mobile apparatus, a positioning location according to the first digital identification or the second digital identification together with the arrangement information.

13. The positioning method of claim 12, further comprising:
comparing received signal strength of the first RF signal with that of the second RF signal, and then determining the positioning location based on the arrangement information.

14. The positioning method of claim 13, wherein the positioning location is determined according to the first digital identification together with the arrangement information if the received signal strength of the first RF signal is greater than that of the second RF signal, and the positioning location is determined according to the second digital identification together with the arrangement information if the received signal strength of the second RF signal is greater than that of the first RF signal.

15. The positioning method of claim 12, wherein the arrangement information is further relevant to the relative relation between the first known location and the second known location.

16. The positioning method of claim 12, wherein the wireless device network further comprises a plurality of directional RF communication devices, and the directional RF communication devices respectively include different digital identifications.

17. A route-planning method employed with a wireless device network and a remote server for positioning in indoor and surrounding areas, wherein the wireless device network is deployed over a predefined area and includes a first directional RF communication device and a second directional RF communication device, the remote server stores arrangement information about the first directional RF communication device and the second directional RF communication device at the first known location and the second known location in the predefined area, the route-planning method is executed by a mobile apparatus, and the mobile apparatus is wirelessly connected to the remote server to access the arrangement information of the directional RF communication devices, the route-planning method comprising:
receiving, by the mobile apparatus, one of a plurality of first RF signals transmitted by the first directional RF communication device or one of a plurality of second RF signals transmitted by the second directional RF communication device, wherein the first RF signals include first digital identification and form a first signal covered zone in the predefined area, and the second RF signals include second digital identification and form a second signal covered zone in the predefined area;
determining, by the mobile apparatus, a positioning location according to the first digital identification or the second digital identification together with the arrangement information;
receiving at least a target location in the predefined area; and
planning at least a route according to the positioning location, the target location, and map information including a relative positional relation between a layout of the indoor and surrounding areas and locations of the respective directional RF communication devices.

18. The route-planning method of claim 17, wherein the wireless device network comprises at least three directional RF communication devices, the directional RF communication devices respectively include different digital identifications, the route is formed by connecting the directional RF communication devices between the positioning location and the target location, a starting point of the route is the first directional RF communication device or the second directional RF communication device, and a terminal point of the route is the first directional RF communication device or the second directional RF communication device which is closest to the target location.

19. A mobile apparatus applied to a positioning system for indoor and surrounding areas, wherein the positioning system includes a wireless device network, a remote server, and the mobile apparatus, the wireless device network is deployed over a predefined area and includes a first directional RF communication device and a second directional RF communication device, the first directional RF communication device is arranged at a first known location in the predefined area, the second directional RF communication device is arranged at a second known location in the predefined area, the remote server stores arrangement information about the first directional RF communication device and the second directional RF communication device at the first known location and the second known location in the predefined area, the mobile apparatus includes a memory unit and one or more processing units, the memory unit stores the arrangement information received from the remote server, a positioning method, and a plurality of instructions, the one or more processing units are coupled with the memory unit, and the one or more processing units execute the instructions and comprise the following procedures:
receiving one of a plurality of first RF signals transmitted by the first directional RF communication device or one of a plurality of second RF signals transmitted by the second directional RF communication device, wherein the first RF signals include first digital identification and form a first signal covered zone in the predefined area, and the second RF signals include second digital identification and form a second signal covered zone in the predefined area; and
determining a positioning location according to the first digital identification or the second digital identification together with the arrangement information.

20. The mobile apparatus of claim 19, wherein the one or more processing units execute the instructions and further comprise the following procedures:
comparing received signal strength of the first RF signal with that of the second RF signal, and then determining the positioning location based on the arrangement information.
